(19) United States
(12) Patent Application Publication
(10) Pub. No.: US 2022/0057998 A1
(43) Pub. Date: Feb. 24, 2022

(54) NON-TRANSITORY COMPUTER-READABLE STORAGE MEDIUM FOR STORING INFORMATION PROCESSING PROGRAM AND INFORMATION PROCESSING APPARATUS

(71) Applicant: FUJITSU LIMITED, Kawasaki-shi (JP)

(72) Inventor: Susumu Koga, Kawasaki (JP)

(73) Assignee: FUJITSU LIMITED, Kawasaki-shi (JP)

(21) Appl. No.: 17/336,440

(22) Filed: Jun. 2, 2021

(30) Foreign Application Priority Data
Aug. 19, 2020 (JP) 2020-138884

(51) Int. Cl. G06F 8/10; G06F 3/06; G05B 19/4155; G06Q 40/00; B25J 9/16

(52) U.S. Cl. CPC G06F 8/10; G06F 3/0608; G06F 3/0653; G05B 2219/50391; G05B 19/4155; G06Q 40/12; B25J 9/1661; G06F 3/0673

(57) ABSTRACT

A non-transitory computer-readable storage medium storing an information processing program for causing a computer to execute processing, the processing including: receiving input of construction conditions and performance information, the construction conditions including a number of robots to be operated in a construction target system, the performance information including a value that corresponds to performance of a deployment server to be deployed in the construction target system; transforming the received construction conditions into a system configuration that satisfies the received construction conditions; obtaining an estimated index corresponding to amount of loads for constructing the construction target system in accordance with the system configuration; and outputting a warning in response to detecting that the estimated index exceeds a predetermined amount stored in a storage device.

### CROSS-REFERENCE TO RELATED APPLICATION

This application is based upon and claims the benefit of priority of the prior Japanese Patent Application No. 2020-138884, filed on Aug. 19, 2020, the entire contents of which are incorporated herein by reference.

### FIELD

The embodiments discussed herein are related to a non-transitory computer-readable storage medium storing an information processing program and an information processing apparatus.

### BACKGROUND

In recent years, robotic process automation (RPA) has attracted attention. The RPA is a scheme in which, for example, various tasks performed on computers are taken care of by robots built in software. By introducing the RPA, it is possible to cause the robots to execute processes that have been manually carried out, and to improve operational efficiency and productivity.

On the other hand, specialized knowledge is requested for the introduction of the RPA. Accordingly, a support service is provided that takes care of or receives a commission to the construction of an RPA system equipped with functions of robots or the like to execute tasks.

Techniques related to an estimation support are known.

Examples of the related art include Japanese Laid-open Patent Publication No. 2006-277392 and International Publication Pamphlet No. WO 2006/070455.

### SUMMARY

According to an aspect of the embodiments, there is provided a non-transitory computer-readable storage medium storing an information processing program for causing a computer to execute processing. In an example, the processing includes: receiving input of construction conditions and performance information, the construction conditions including a number of robots to be operated in a construction target system, the performance information including a value that corresponds to performance of a deployment server to be deployed in the construction target system; transforming the received construction conditions into a system configuration that satisfies the received construction conditions; obtaining an estimated index corresponding to amount of loads for constructing the construction target system in accordance with the system configuration; and outputting a warning in response to detecting that the estimated index exceeds a predetermined amount stored in a storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary server construction flow;

FIG. 2 is a diagram exemplifying a support system according to an embodiment;

FIG. 3 is a diagram exemplifying a functional block configuration of a support server according to an embodiment;

FIG. 4 is a diagram exemplifying an input screen according to an embodiment;

FIG. 5 is a diagram exemplifying customer information according to an embodiment;

FIG. 6 is a diagram exemplifying construction condition information according to an embodiment;

FIG. 7 is a diagram exemplifying registration upper limit information according to an embodiment;

FIG. 8 is a diagram exemplifying estimation information according to an embodiment;

FIGS. 9A and 9B illustrate diagrams each exemplifying a display screen illustrating an estimation result according to an embodiment;

FIG. 10 is a diagram exemplifying simultaneous operation upper limit information according to an embodiment;

FIGS. 11A and 11B illustrate diagrams each exemplifying output of a warning on an input screen according to an embodiment;

FIGS. 12A and 12B illustrate diagrams each exemplifying a status setting for a business negotiation;

FIG. 13 is a diagram exemplifying an operation flow of a construction support process for an RPA system according to an embodiment;

FIG. 14 is a diagram exemplifying a flow of a construction support process for an RPA system according to an embodiment; and

FIG. 15 is a diagram exemplifying a hardware configuration of a computer to implement a support server according to an embodiment.

### DESCRIPTION OF EMBODIMENT(S)

For example, in a case where an RPA support service is provided, employees of the customer involved in the tasks are interviewed to collect information related to the construction of the RPA system, and then the RPA system is constructed based on the collected information. However, for example, due to information sharing failure inside the customer, there is a case in which the collection of information related to the construction of the RPA system, estimation of costs for constructing the RPA system, and the like are insufficient. In a case where the development is carried out in a state in which the information collection, cost estimation, and the like are insufficient as described above, there may arise risks, as a result, that an expected cost is generated in a post-process, an RPA server takes a longer time than expected to construct, and obtaining a profit corresponding to the provided service may not be expected. Therefore, there is a demand for the provision of a technique that supports collection of information related to the construction of an RPA system, cost estimation of the RPA system construction, and the like.

In an aspect of the embodiments disclosed below, there is provided a solution to reduce a risk raised by inaccuracy in estimation in the construction of an RPA system.

Hereinafter, some embodiments of the present disclosure will be described in detail with reference to the drawings. The corresponding components in a plurality of the drawings are denoted by the same reference signs.

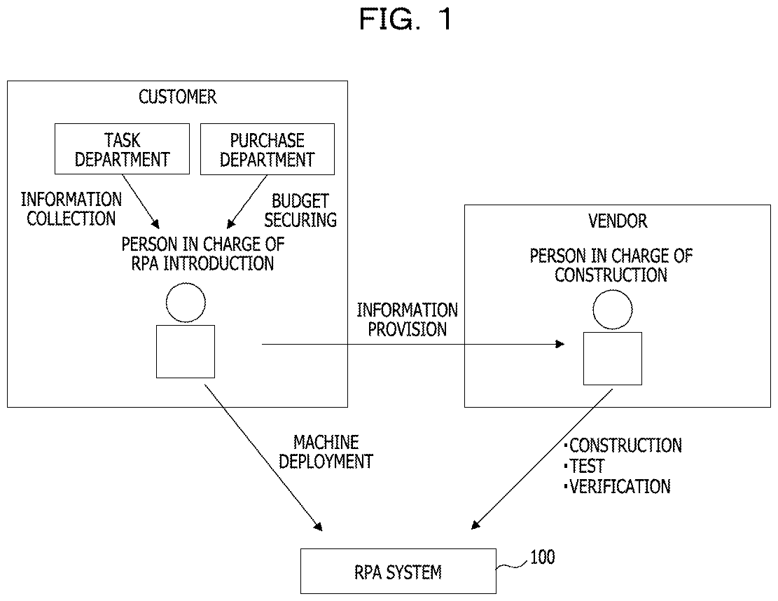

FIG. 1 illustrates an exemplary server construction flow. For example, in a case where the introduction of RPA is decided by a customer, a person in charge of RPA introduction performs preparations such as collecting information from a task department carrying out a task to be taken care of by an RPA robot, and securing a budget from a purchase department. The above person requests a vendor expected to provide a service of constructing an RPA system 100 to construct the RPA system 100 by supplying the collected information thereto. In addition, the above person in the customer deploys a machine such as a server to construct the RPA system 100.

When a construction operator of the vendor in charge of constructing the RPA system 100 receives the request to construct the RPA system 100, the construction operator interviews the person in charge of RPA introduction, and the like, and is supplied with information related to the construction of the RPA system 100. The construction operator constructs the RPA system 100 based on the supplied information related to the construction of the RPA system 100, and after testing, verification, and the like being performed, the constructed RPA system 100 is delivered to the customer.

However, for example, there is a case in which the person in charge of RPA introduction belongs to a department such as an information technology (IT) department, which is a different department from the task department to introduce the RPA and is also different from the purchase department to manage the budget. As a result, there is a case in which sharing of the information related to the introduction of the RPA system 100 becomes insufficient in the customer, so that some information is lacked without being supplied to the construction operator, the supply of the information is delayed, or the like. Thus, in a case where the system construction is carried out in a state in which the information collection, cost estimation, and the like are insufficient as described above, an unexpected cost may be generated at a timing when constructing the RPA system 100 or in a post-process at a timing when starting the operation of the RPA system or the like, the system construction may take a longer development time than expected, or the like. For example, a problem may arise due to a difference between requirements of the RPA system 100 to be met in order to execute the actual task and the RPA system 100 planned to be constructed. In this case, an additional cost may be generated, and there may arise a risk that obtaining a profit corresponding to the service provided by the vendor may not be expected, an unprofitable situation such as being below cost may be brought about, or the like. Therefore, there is a demand for the provision of a technique able to support collection of information related to the construction of an RPA system, estimation of costs, and the like, and reduce a risk raised by inaccuracy in estimation of the construction of the RPA system.

The embodiments described below support the collection of information related to the construction of an RPA system. For example, by presenting information to be collected for constructing an RPA system to a customer, the customer may be prompted to provide the information related to the construction of the RPA system. When a situation where a profit is not expected is predicted based on the collected information related to the construction of the RPA system, a warning is output. This makes it possible to reduce a risk of occurrence of a situation where a profit corresponding to the provided construction service of the RPA system 100 is not expected, for example.

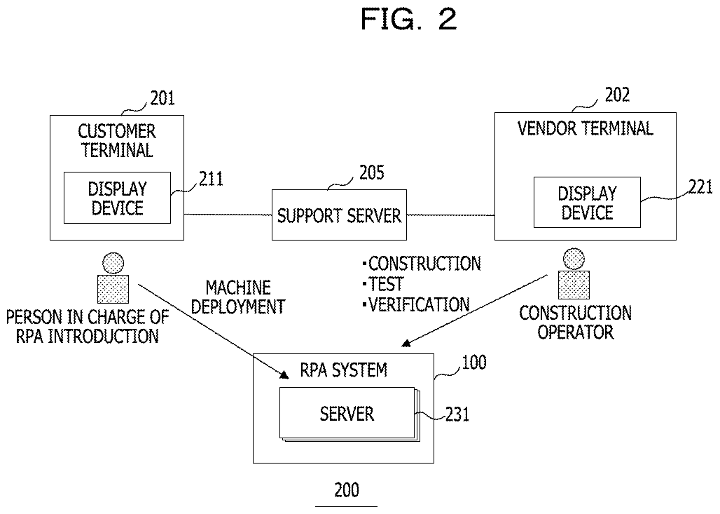

FIG. 2 is a diagram exemplifying a support system 200 configured to provide a service to support the construction of the RPA system 100 according to an embodiment. In FIG. 2, the support system 200 includes, for example, a customer terminal 201, a vendor terminal 202, the RPA system 100, and a support server 205.

The customer terminal 201 may be, for example, a terminal used by a person in charge of introducing the RPA system 100 in the customer. The vendor terminal 202 may be, for example, a terminal used by a person in charge of construction of the vendor that provides a service for constructing the RPA system 100. The RPA system 100 is an RPA system to be constructed by the person of the vendor in charge of construction. The support server 205 is, for example, a server configured to execute a process of supporting the collection of information related to the construction of the RPA system 100 according to the embodiment, the estimation of costs, and the like. The customer terminal 201, the vendor terminal 202, and the support server 205 may be information processing apparatuses such as a personal computer (PC), a mobile PC, a tablet terminal, a smartphone, and a cellular phone. The customer terminal 201 may include, for example, a display device 211. The vendor terminal 202 may include, for example, a display device 221. The RPA system 100 may be constructed with, for example, at least one server 231.

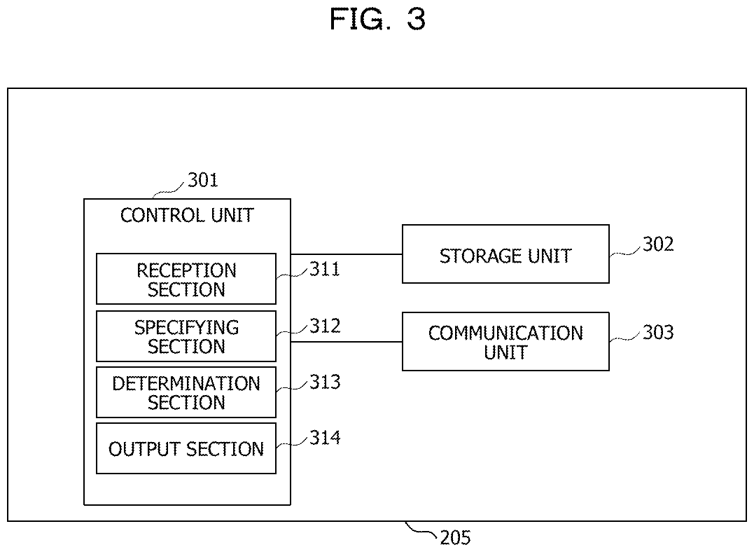

FIG. 3 is a diagram exemplifying a functional block configuration of the support server 205 according to the embodiment. The support server 205 includes, for example, a control unit 301, a storage unit 302, and a communication unit 303. The control unit 301 includes, for example, a reception section 311, a specifying section 312, a determination section 313, and an output section 314, and may include other functional sections. The storage unit 302 of the support server 205 stores, for example, information such as customer information 500, construction condition information 600, registration upper limit information 700, estimation information 800, simultaneous operation upper limit information 1000, status information 1201, and warning target designation information 1202, which will be described later. For example, the communication unit 303 may communicate with other devices such as the customer terminal 201 and the vendor terminal 202 in accordance with instructions from the control unit 301. Each of these units and sections, and the information stored in the storage unit 302 will be described later in detail.

In one embodiment, the support server 205 may provide a web service for supporting the construction of the RPA system 100. In this case, for example, when the person of the customer operates the customer terminal 201 to access a predetermined web page of the support service via the browser, an input screen 400 may be displayed on the display device 211 of the customer terminal 201. The input screen 400 is, for example, a display screen for receiving input of information related to a business negotiation with respect to the construction service of the RPA system 100 from the customer. For example, the control unit 301 of the support server 205 may receive input of information on the business negotiation and the corresponding customer and may receive, in the business negotiation, input of construction conditions of the RPA system 100 to be constructed, on the input screen 400.

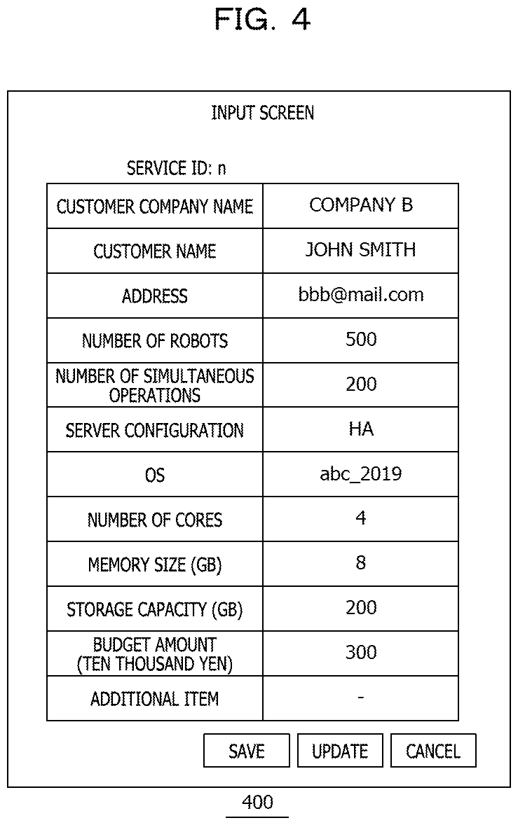

FIG. 4 is a diagram exemplifying the input screen 400 according to the embodiment. The input screen 400 corresponds to, for example, a service ID assigned to identify a business negotiation. In FIG. 4, the input screen 400 includes, for example, a customer company name, a customer name, an address, the number of robots, the number of simultaneous operations, a server configuration, an operating system (OS), the number of cores, a memory size, a storage capacity, a budget amount, and an additional input item. The customer company name is, for example, information indicating the company name of the customer in the business negotiation identified by the service ID. The customer name is, for example, information indicating the name of a person of the customer in the business negotiation corresponding to the service ID. The address may be, for example, a mail address of the customer company or a mail address of the person thereof in the business negotiation identified by the service ID. The number of robots is, for example, the maximum number of robots planned to operate in the RPA system 100 to be introduced by the customer. The number of simultaneous operations is the maximum number of robots planned to operate simultaneously in the RPA system 100. The server configuration is, for example, information indicating whether to configure the RPA system 100 with high availability. The OS is, for example, information indicating a type of OS introduced into the server 231 in the RPA system 100 constructed in the customer. The number of cores is, for example, information indicating the number of cores in a central processing unit (CPU) mounted in the server 231 of the RPA system 100 introduced by the customer. The memory size is, for example, information indicating the size of a memory mounted in the server 231 of the RPA system 100 to be introduced by the customer, and may be registered in a unit of gigabyte (GB). The storage capacity is, for example, information indicating the storage capacity of a storage device mounted in the server 231 of the RPA system 100 to be introduced by the customer, and may be registered in a unit of gigabyte (GB). The storage device may be, for example, a hard disk drive (HDD), a solid-state drive (SSD), or the like. The budget amount is, for example, information indicating a budget to be allocated by the customer for the construction of the RPA system 100. As the additional item, for example, in a case where an additional support is requested in addition to the construction of the RPA system 100, the content of the request may be registered. The content of the request for the additional support may include, for example, a request for the construction of a database server and a request for a remote business trip.

As described above, the control unit 301 may receive input of the information related to the customer involved in the business negotiation corresponding to the service ID, such as the customer company name, the customer name, and the address on the input screen 400. The control unit 301 may receive input of the information related to the robots to operate in the RPA system 100 to be constructed, such as the number of robots and the number of simultaneous operations on the input screen 400. On the input screen 400, the control unit 301 may receive input of performance information related to the performance of the server deployed in the RPA system 100, such as the server configuration, the OS, the number of cores, the memory size, the storage capacity, and the like.

The person of the customer may input information related to the construction of the RPA system 100 to the support server 205, for example, by inputting information in each item of the input screen 400 displayed on the display device 211 of the customer terminal 201 and performing an operation of save, update, or the like. When the control unit 301 of the support server 205 receives the input of the information related to the construction of the RPA system 100, the control unit 301 may register a record in the customer information 500 or update a record therein, with the customer information contained in the input information.

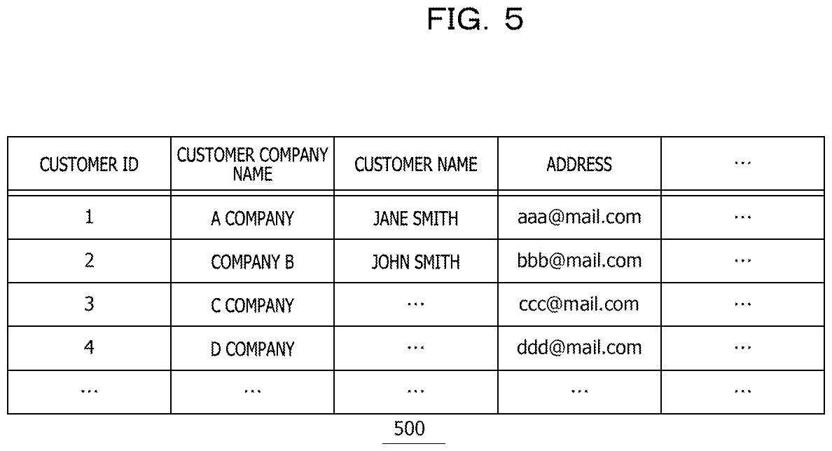

FIG. 5 is a diagram exemplifying the customer information 500 according to the embodiment. In the customer information 500, information on the customers to receive the construction service of the RPA system 100 is registered. In an example of FIG. 5, records in each of which pieces of information such as a customer ID, a customer company name, a customer name, and an address are associated with each other, are registered in the customer information 500. For example, the control unit 301 of the support server 205 may register, in the customer information 500, a record in which the customer company name, the customer name, and the address input to the input screen 400 are associated with the customer ID for identifying the customer. Thus, for example, the control unit 301 may acquire the information of the customer corresponding to the customer ID by referring to the customer information 500.

The control unit 301 of the support server 205 registers a record in the construction condition information 600 or updates the information of a record therein, with the information of the construction conditions, input to the input screen 400, of the RPA system 100 as the construction target.

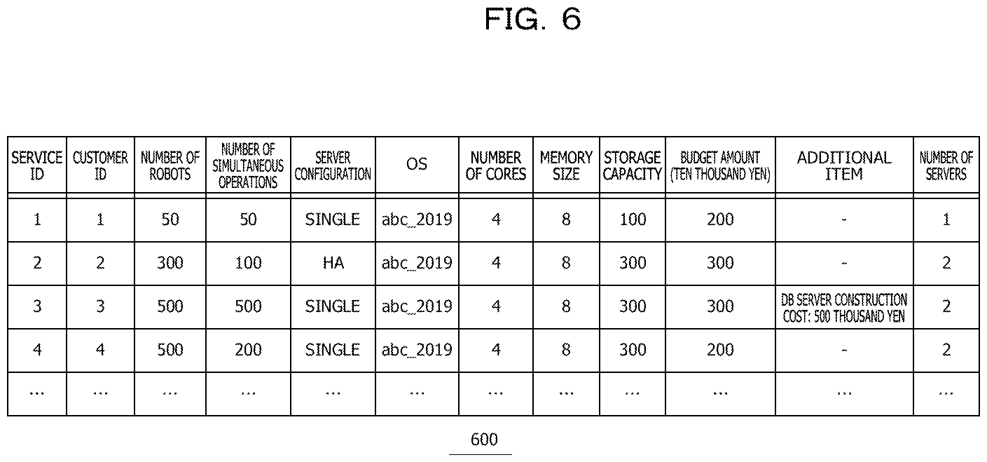

FIG. 6 is a diagram exemplifying the construction condition information 600 according to the embodiment. In an example of FIG. 6, in the construction condition information 600, records are registered in each of which pieces of information on a service ID, a customer ID, the number of robots, the number of simultaneous operations, a server configuration, an OS, the number of cores, a memory size, a storage capacity, a budget amount, an additional item, and the number of servers are associated with each other.

In the service ID of the construction condition information 600, for example, the service ID assigned to identify the business negotiation input to the input screen 400 is registered. In the customer ID of the construction condition information 600, for example, the customer ID of the customer information 500 corresponding to the customer of the business negotiation identified by the service ID in the record may be registered. In the number of robots, the number of simultaneous operations, the server configuration, and the OS of the construction condition information 600, pieces of information on the number of robots, the number of simultaneous operations, the server configuration, and the OS collected on the input screen 400 may be registered respectively. In the information of the number of cores, the memory size, the storage capacity, the budget amount, and the additional item of the construction condition information 600, pieces of information on the number of cores, the memory size, the storage capacity, the budget amount, and the additional item collected on the input screen 400 may be registered respectively. The number of servers in the construction condition information 600 is, for example, information indicating the number of servers 231 used in constructing the RPA system 100. The number of servers 231 used in constructing the RPA system 100 may be determined based on, for example, the construction conditions registered in the record of the construction condition information 600.

Next, an example of specifying a system configuration of the RPA system 100, which satisfies the construction conditions, will be described. In the following, an example of specifying the number of servers used in the construction of the RPA system 100 as a system configuration will be described while using the record of the service ID being 4 in the construction condition information 600 as an example.

(Specifying Number of Servers)

The control unit 301 acquires the information of the storage capacity of 300 (GB) from the record of the service ID being 4 in the construction condition information 600. The control unit 301 specifies a registration upper limit number of robots corresponding to the server configuration from the registration upper limit information 700, for example.

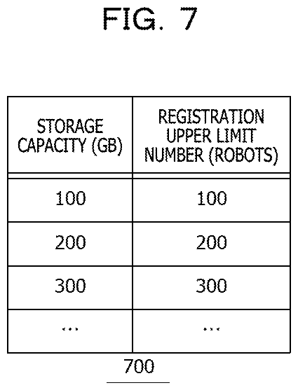

FIG. 7 is a diagram exemplifying the registration upper limit information 700 according to the embodiment. FIG. 7 illustrates an example in which the number of robots able to be registered is limited by the storage capacity, and the registration upper limit number indicating the upper limit of the number of robots able to be registered for each server 231 is registered being associated with the storage capacity. Thus, the control unit 301 may acquire, from the storage capacity of 300 (GB) of the record of the service ID being 4 in the construction condition information 600, the corresponding registration upper limit number of 300, for example.

Subsequently, the control unit 301 acquires the number of robots of 500 indicating the number of robots that the customer plans to register in the RPA system 100, from the record of the service ID being 4 in the construction condition information 600. For example, the control unit 301 may specify the number of servers by the following calculation from the acquired number of robots of 500 and the acquired registration upper limit number of 300.

The number of servers: 500/300=1.67, or two servers (digits after the decimal point are rounded up)

Then, the control unit 301 registers the specified number of servers of two in the number of servers in the record of the service ID being 4 in the construction condition information 600.

### (Estimation of Construction Costs of RPA System 100)

The estimation of the construction costs of the RPA system 100 will be described. For example, the control unit 301 may estimate the construction costs of the RPA system 100 by referring to the specified system configuration of the RPA system 100 and the estimation information 800.

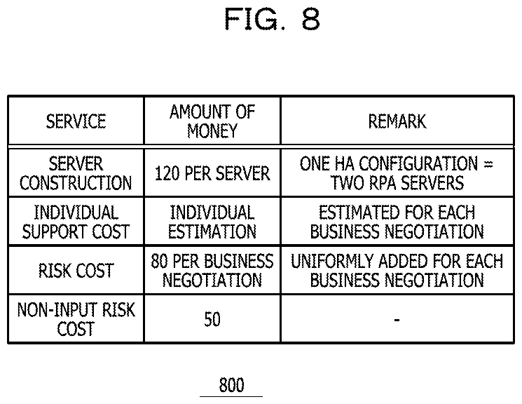

FIG. 8 is a diagram exemplifying the estimation information 800 according to the embodiment. In the estimation information 800, for example, records in each of which a service, an amount of money, and a remark are associated with each other are registered. In the service therein, for example, a service for which an expense claim is made in the construction of the RPA system 100 is registered. The amount of money is, for example, a cost for providing the service in the record. In the remark therein, for example, description on the provision of the service in the record may be registered.

For example, a server construction therein refers to a record indicating a cost per server for constructing the servers 231 used in the RPA system 100. An individual support cost is, for example, a cost added when a support is individually requested in each business negotiation, and the amount of money may be individually set. For example, the individual support cost may be a cost of supporting a request for additionally constructing a database server, or a business trip cost with respect to a request for a remote business trip. A risk cost is, for example, a cost added for each business negotiation, and is a cost for dealing with any unexpected situation. A non-input risk cost is, for example, a cost added to an estimated amount of money to deal with a case where the estimation is inaccurate due to a non-input item. The non-input risk cost may be set to, for example, an amount of money calculated by evaluating a risk of a decrease in estimation accuracy due to non-input of a predetermined item in the input screen 400.

For example, in the record of the service ID being 4 in the construction condition information 600, the number of servers is two, and the server configuration is set to be single. Therefore, the control unit 301 may specify the number of servers of two in the RPA system 100 as it is, as the number of servers used for constructing the RPA system 100.

Then, the control unit 301 multiplies the number of servers being 2 by the server construction being 120 per server in the estimation information 800, thereby making it possible to determine a cost of 240 (ten thousand yen) for server construction of the RPA system 100.

2 servers×120 (ten thousand yen)=240 (ten thousand yen)

When the server configuration is set to high availability (HA), the control unit 301 may double the number of servers to calculate the cost for the server construction.

The risk cost in the estimation information 800 is, for example, a cost that is uniformly added for each business negotiation. Accordingly, the control unit 301 may further add the risk cost being 80 per business negotiation to the server construction cost being 240 (ten thousand yen) to calculate an estimated amount of money as the estimation of the cost for constructing the RPA system 100.

Estimated amount of money: 240 (ten thousand yen)+80 (ten thousand yen)=320 (ten thousand yen)

In the record of the service ID being 4 of the construction condition information 600, for example, since there is no description in the additional item field, any individual support cost may not be present. Further, since there is not any non-input item in the record of the service ID being 4 of the construction condition information 600, any non-input risk cost may not be added.

As described above, the control unit 301 may calculate the estimated amount of money to be 320 (ten thousand yen) for the record of the service ID being 4 in the construction condition information 600. Then, the control unit 301 may determine whether the budget is sufficient by comparing the estimated amount of money of 320 (ten thousand yen) for the record of the service ID being 4 in the construction condition information 600 with a budget amount of 300 (ten thousand yen).

For example, when the estimated amount of money is equal to or less than the budget amount, the budget is considered to be sufficient. In this case, the control unit 301 outputs the estimated amount of money. For example, the control unit 301 causes the display device 211 of the customer terminal 201 accessing the support server 205, the display device 221 of the vendor terminal 202 accessing the support server 205, or the like to display a display screen 901, and outputs the estimated amount of money.

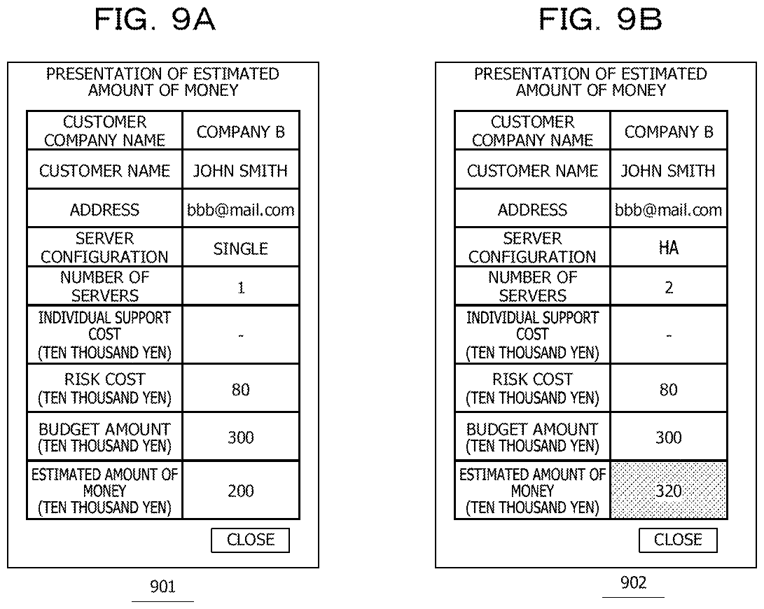

FIG. 9 (i.e., FIGS. 9A and 9B) includes diagrams each exemplifying a display screen illustrating an estimation result according to the embodiment. FIG. 9A is a diagram exemplifying the display screen 901 to be displayed when the budget is sufficient. On the display screen 901, for example, an estimated amount of money is displayed in addition to information of the customer information, server configuration, cost breakdown, budget amount, and the like. Because of this, for example, by referring to the display screen 901, a user of the service provided by the support server 205 may recognize that the budget is sufficient.

On the other hand, for example, in a case where the estimated amount of money exceeds the budget amount, the budget is insufficient, and thus the control unit 301 may output a warning. For example, the control unit 301 outputs a warning indicating that the budget is insufficient by displaying a display screen 902 on the display device 211 of the customer terminal 201 accessing the support server 205 or the display device 221 of the vendor terminal 202 accessing the support server 205, or the like.

FIG. 9B is a diagram exemplifying the display screen 902 to be displayed when the budget is insufficient. On the display screen 902, an estimated amount of money is displayed in addition to the information of the customer information, server configuration, cost breakdown, and budget amount, for example. In the display screen 902, since the estimated amount of money exceeds the budget amount and the budget is insufficient, the background of the field of the estimated amount of money is displayed being highlighted. When the budget is insufficient as discussed above, by displaying the display screen 902 with the field of the estimated amount of money highlighted, a warning may be output for a viewer of the display screen 902. Thus, for example, the viewer having viewed the display screen 902 may recognize that the budget is insufficient. With this, for example, a situation in which the service providing vendor accepts a request from the customer in an unprofitable state may be suppressed.

Although the example in which the number of servers is specified based on the registration upper limit of the robots corresponding to the storage capacity is described above, the embodiment is not limited thereto. For example, the control unit 301 may also specify the number of servers based on the number of robots to be simultaneously operated.

For example, the number of simultaneous operations is set to 500 (robots) in a record of the service ID being 3 of the construction condition information 600. For example, the control unit 301 acquires the upper limit of the number of simultaneously executable robots in accordance with the construction conditions from the simultaneous operation upper limit information 1000.

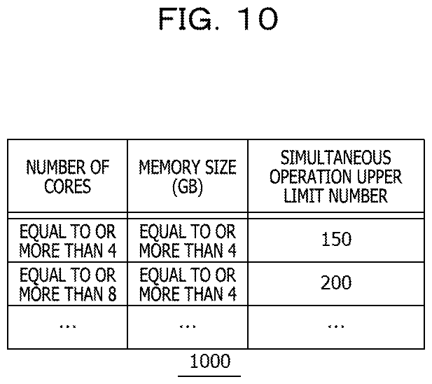

FIG. 10 is a diagram exemplifying the simultaneous operation upper limit information 1000 according to the embodiment. In the example of FIG. 10, in the simultaneous operation upper limit information 1000, the upper limits of the numbers of simultaneously operable robots are registered each associated with the number of cores and the memory size. For example, in the record of the service ID being 4 of the construction condition information 600, the number of cores is set to four, and the memory size is set to eight. Thus, the control unit 301 may specify, from the simultaneous operation upper limit information 1000, a record in which the number of cores is equal to or more than four and the memory size is equal to or more than eight, and may acquire the simultaneous operation upper limit number of 200.

Then, the control unit 301 divides the acquired number of simultaneous operations being 500 (robots) by the simultaneous operation upper limit number being 200, thereby making it possible to determining the number of servers to be used for constructing the RPA system 100 as a system configuration.

The number of servers: 500/200=2.5, or three servers (digits after the decimal point are rounded up)

In another embodiment, the control unit 301 may execute both the specification of the number of servers based on the registration upper limit of the robots corresponding to the storage capacity and the specification of the number of servers based on the simultaneous operation upper limit number of the robots corresponding to the number of cores and the memory size as described above. In this case, the control unit 301 may select a larger number from the two specified numbers of servers, and may determine the selected number as the number of serves used for constructing the RPA system 100.

Next, an input omission warning process during the collection of information related to the construction of the RPA system 100 will be described. For example, when information related to the construction of the RPA system 100 is collected from the customer via the input screen 400, input omission may occur. The input omission may occur, for example, when the customer forgets to input the information or when the information is unable to be input due to insufficient research within the customer. For example, in a case where the information suffering input omission is information used for estimating the construction cost of the RPA system 100, the accuracy of the estimation may decrease. Therefore, when there exists input omission, the control unit 301 may output a warning.

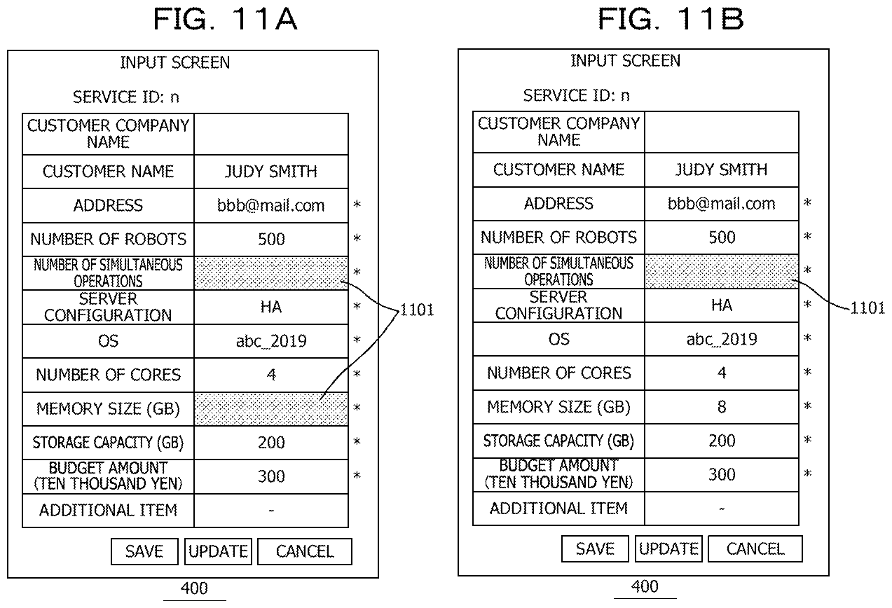

FIG. 11 (i.e., FIGS. 11A and 11B) includes diagrams each exemplifying output of a warning on the input screen 400 according to the embodiment. In the example of FIG. 11, “*” is given to predetermined items for which a warning is output in a case of non-input. For example, in FIG. 11, “*” is given to the fields from the address down to the budget amount (ten thousand yen). In FIG. 11A, no information is input to input fields 1101 of the number of simultaneous operations and the memory size. In FIG. 11B, no information is input to the input field 1101 of the number of simultaneous operations. In the example of FIG. 11A and FIG. 11B, the input fields 1101, to which no information is input, are highlighted to output warnings telling that there exists input omission on the input screen 400. Thus, a viewer of the input screen 400 may easily notice the input omission in the input fields 1101 by referring to the input screen 400.

For example, when there exists input omission, the control unit 301 of the support server 205 may calculate an estimated amount of money in accordance with a risk of a decrease in estimation accuracy due to the input omission. Hereinafter, a calculation of the estimated amount of money in the case where there exists input omission is exemplified.

As described above, for example, when there is input to a set of input fields of the number of robots and the storage capacity (GB) in the input screen 400, the number of servers 231 to be used in the RPA system 100 may be estimated. Alternatively, when there is input to a set of input fields of the number of simultaneous operations, the number of cores, and the memory size, the number of servers 231 to be used in the RPA system 100 may be estimated. Accordingly, as exemplified in FIG. 11A, when there is input omission in each of the two sets of input fields, the control unit 301 may output the input screen 400 including warnings for the input omission to prompt the customer to perform input, and wait for the input from the customer.

On the other hand, as exemplified in FIG. 11B, when there is input to at least one of the two sets of input fields, the control unit 301 may calculate an estimated amount of money based on the information of the set of input fields input with data. For example, in the input screen 400 in FIG. 11, there is input to a set of input fields of the number of robots and the storage capacity (GB), but there exists input omission in the field of the number of simultaneous operations in a set of input fields of the number of simultaneous operations, the number of cores, and the memory size. In this case, the control unit 301 may calculate the estimated amount of money by using information in the set of input fields of the number of robots and the storage capacity (GB).

As illustrated in the input screen 400, the number of robots is set to 500 (robots), and the storage capacity is set to 200 (GB). From the storage capacity of 200 (GB), the control unit 301 may specify a registration upper limit number of 200 (robots) based on the registration upper limit information 700 in FIG. 7. Then, the control unit 301 divides the acquired number of robots being 500 (robots) by the registration upper limit number being 200, thereby making it possible to determine the number of servers to be used for constructing the RPA system 100 as a system configuration.

The number of servers: 500/200=2.5, or three servers (digits after the decimal point are rounded up)

Subsequently, for example, based on the determined system configuration and the estimation information 800, the control unit 301 estimates the cost for constructing the system to calculate the estimated amount of money. For example, in the input screen 400 in FIG. 11(b), since the server configuration is set to HA, the number of servers is doubled, resulting in six servers by a calculation of 3 (servers) multiplied by 2. Since the server construction is set to be 120 per server in the estimation information 800, the cost for constructing six servers may be calculated as follows.

6×120=720 (ten thousand yen)

Further, the risk cost in the estimation information 800 is added to the cost for constructing the server to obtain the following amount of money.

720+80=800 (ten thousand yen)

In the example of the input screen 400, of the predetermined fields marked with “*” that request input, the field of the number of simultaneous operations is in a state of non-input. Therefore, the control unit 301 may further add 50 (ten thousand yen) as the non-input risk cost in the estimation information 800, so as to calculate the estimated amount of money to be 850 (ten thousand yen).

800+50=850 (ten thousand yen)

Since the calculated estimated amount of money of 850 (ten thousand yen) exceeds the budget amount of 300 (ten thousand yen) in the input screen 400, the control unit 301 may output display information for displaying the display screen including the warning as exemplified in the display screen 902.

In the above-described embodiment, an example is described in which a warning is output when the estimated amount of money exceeds the budget amount, but the embodiment is not limited thereto. For example, in another embodiment, whether to output a warning may be controlled based on the progress of construction of the system as the construction target.

For example, in another embodiment, the storage unit 302 may store the status information 1201, in which a status indicating the progress of construction of the RPA system 100 is registered for each business negotiation. When the status of a business negotiation set in the status information is a predetermined status, the control unit 301 may perform control to suppress output of a warning.

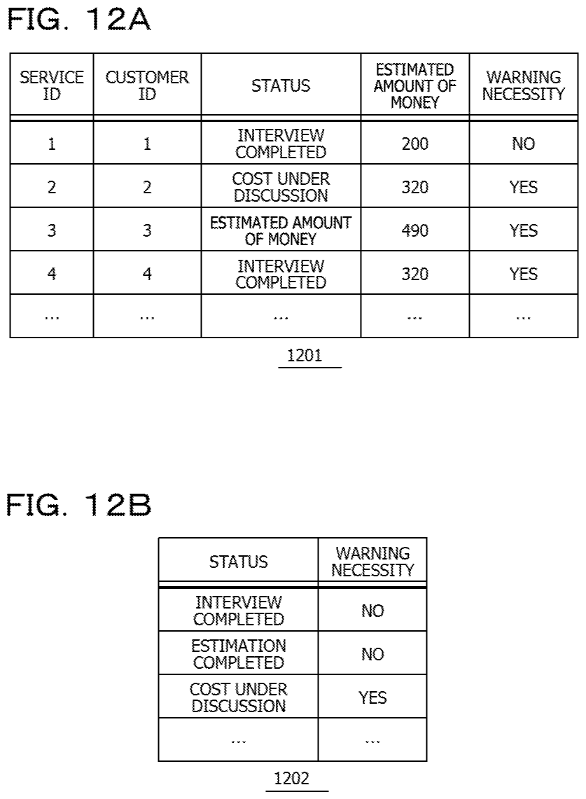

FIG. 12 (i.e., FIGS. 12A and 12B) includes diagrams each exemplifying a status setting for a business negotiation. FIG. 12A exemplifies the status information 1201. In the status information 1201, for example, records are registered in each of which pieces of information of a service ID, a customer ID, a status, an estimated amount of money, and necessity of a warning are associated with each other. The service ID is, for example, an identifier for identifying a business negotiation corresponding to the record. The customer ID is, for example, an identifier for identifying a customer of the business negotiation corresponding to the record. The status is, for example, information indicating a status of the business negotiation corresponding to the record. The estimated amount of money is, for example, information indicating an estimated amount of money for the business negotiation corresponding to the record. The warning necessity is, for example, information indicating whether to output a warning for the business negotiation corresponding to the record. For example, the control unit 301 may output a warning when the warning necessity is set to “YES”

FIG. 12B is a diagram exemplifying the warning target designation information 1202 for designating a status of a warning execution target. In the warning target designation information 1202, information of “YES” indicating that warning output is to be executed or information of “NO” indicating that warning output is not to be executed is registered being associated with the status. For example, the control unit 301 may set the warning necessity corresponding to the status of the record in the status information 1201 by referring to the warning target designation information 1202.

For example, in a case where the interview is completed or the estimation is completed, the discussion with the customer on the cost is completed. Accordingly, in the warning target designation information 1202 in FIG. 12B, the warning necessity is set to “NO” in the status where the interview is completed and in the status where the estimation is completed. On the other hand, in a case where the cost is under discussion with the customer, a change of the system configuration, a change of the budget amount, and the like are negotiable with the customer. Thus, in the warning target designation information 1202 in FIG. 12B, the warning necessity is set to “YES” in the status where the cost is under discussion. The status is not limited to the above-described example, and various statuses may be set in accordance with usage. For example, the status may further include starting of an interview indicating a state where an interview is started, waiting for a customer's answer indicating a state of waiting for an answer from the customer, waiting for a customer's question indicating a state of waiting for a question from the customer, and the like.

The control unit 301 may suppress the output of warning in the business negotiation in which the warning necessity is set to “NO” in the status information 1201.

The setting of the warning necessity in each of the status information 1201 and the warning target designation information 1202 is not limited to the above example, and a user of the support system 200 may optionally set the warning necessity.

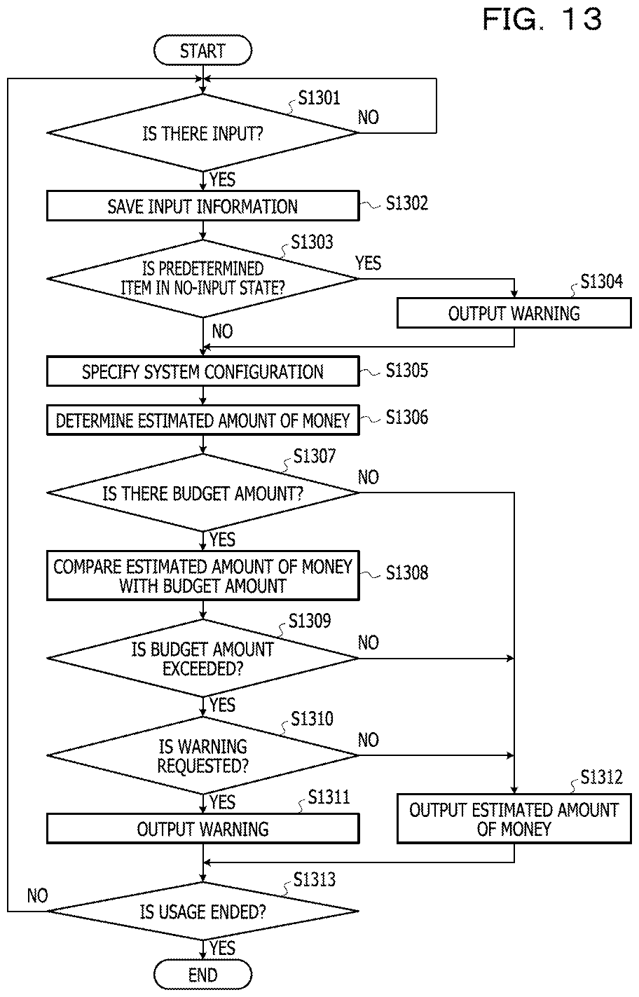

FIG. 13 is a diagram exemplifying an operation flow of a construction support process for the RPA system 100 according to the embodiment. For example, when the customer terminal 201 or the vendor terminal 202 accesses a web page for displaying the input screen 400, the control unit 301 of the support server 205 may start the operation flow in FIG. 13.

In step 1301 (hereinafter, each step is described as “S”, and expressed as S1301, for example), the control unit 301 determines whether information on the construction of the RPA system 100 is input to the input screen 400. For example, when information is input to the input screen 400 from the customer terminal 201 or the vendor terminal 202 and a button for saving or updating is pressed, the control unit 301 may determine that there is input. In a case where input has not been carried out in S1301 (NO in S1301), the flow repeats processing in S1301. On the other hand, in a case where there is input (YES in S1301), the flow goes to S1302.

In S1302, the control unit 301 saves the information input to the input screen 400. For example, in a case where the customer information input to the input screen 400 has not been registered in the customer information 500, the control unit 301 registers the customer information input to the input screen 400 in the customer information 500. When the construction conditions of the RPA system 100 input to the input screen 400 have not been registered in the construction condition information 600, the control unit 301 registers the construction conditions of the RPA system 100 input to the input screen 400 in the construction condition information 600.

In S1303, the control unit 301 determines whether a predetermined item is yet to be input on the input screen 400. For example, the control unit 301 may determine YES in S1303 when there is input omission in any input field of a set of input fields of the number of robots and the storage capacity (GB) and a set of input fields of the number of simultaneous operations, the number of cores, and the memory size. When there is input omission (YES in S1303), the flow goes to S1304, in which the control unit 301 outputs display information for displaying the input screen 400 including a warning as exemplified in FIGS. 11(a) and 11(b), and then the flow goes to S1305. When there is no input omission in S1303 (NO in S1303), the flow goes to S1305.

In S1305, the control unit 301 specifies a system configuration that satisfies the input construction conditions. For example, the control unit 301 may specify the number of servers 231 used to construct the RPA system 100 based on the number of robots registered in the construction condition information 600 from the input screen 400 and the registration upper limit number of robots in accordance with the storage capacity. Alternatively, for example, the control unit 301 may specify the number of servers 231 used to construct the RPA system 100 based on the number of simultaneous operations of robots registered in the construction condition information 600 from the input screen 400 and the simultaneous operation upper limit number of robots.

In S1306, the control unit 301 calculates an estimated amount of money. For example, based on the estimation information 800, the control unit 301 determines the estimated amount of money corresponding to the system configuration specified in S1305.

In S1307, the control unit 301 determines whether a budget amount is set. When the budget amount is not set in the record registered in the construction condition information 600 from the input screen 400 (NO in S1307), the flow goes to S1312. On the other hand, when the budget amount is set (YES in S1307), the flow goes to S1308.

In S1308, the control unit 301 compares the estimated amount of money calculated in S1306 with the budget amount. In S1309, the control unit 301 determines whether the calculated estimated amount of money exceeds the budget amount. When the estimated amount of money does not exceed the budget amount (NO in S1309), the flow goes to S1312. On the other hand, when the estimated amount of money exceeds the budget amount (YES in S1309), the flow goes to S1310.

In S1310, the control unit 301 determines, for the business negotiation identified by the service ID in the input screen 400, whether the warning necessity corresponding to the status is “Yes”. For example, when the warning necessity corresponding to the status is set to “NO” in the status information 1201 (NO in S1310), the flow goes to S1312. On the other hand, when the warning necessity corresponding to the status is set to “YES” in the status information 1201 (YES in S1310), the flow goes to S1311.

In S1311, the control unit 301 outputs a warning indicating that the estimated amount of money exceeds the budget amount. As exemplified in the display screen 902, the control unit 301 may output display information for displaying a display screen including a warning that is presented in an emphasized manner such as highlighting. In one example, the control unit 301 may cause the display device 211 of the customer terminal 201, the display device 221 of the vendor terminal 202, or the like to display a display screen including a warning so as to output the warning telling that the budget is insufficient.

In S1312, the control unit 301 outputs the estimated amount of money. The control unit 301 may output display information for displaying a display screen including the estimated amount of money as exemplified in the display screen 901. In one example, the control unit 301 may cause the display device 211 of the customer terminal 201, the display device 221 of the vendor terminal 202, or the like to display a display screen including the estimated amount of money so as to output the estimated amount of money.

In S1313, the control unit 301 determines whether an instruction to end the use of the support service is input. In a case where the instruction to end the use of the support service is not input (NO in S1313), the flow returns to S1301 and the process is repeated. On the other hand, in a case where the instruction to end the use of the support service is input (YES in S1313), the operation flow is ended. For example, a user of the support service provided by the support server 205 may input the instruction to end the use of the support service to the support server 205, when the user intends to end the use of the support service.

According to the above-described operation flow in FIG. 13, the control unit 301 specifies a system configuration that satisfies the construction conditions of the RPA system 100, and calculates the estimated amount of money in accordance with the specified system configuration. In a case where the estimated amount of money exceeds the budget amount, the control unit 301 outputs a warning. This may reduce a risk raised by inaccuracy in estimation in the construction of the RPA system 100. For example, it is possible to suppress a situation in which the service providing vendor accepts a request from the customer in an unprofitable state. For example, the customer may suppress a situation in which an additional cost is generated after the development of construction of the RPA system 100 has progressed.

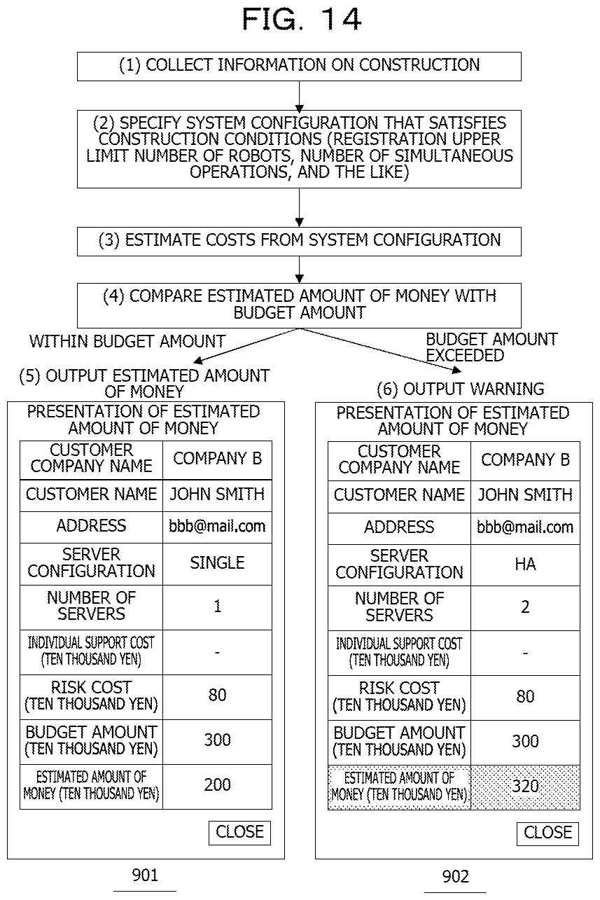

FIG. 14 is a diagram exemplifying a flow of a construction support process for the RPA system 100 according to an embodiment. The control unit 301 of the support server 205 collects, for example, information on the construction of the RPA system 100 ((1) in FIG. 14).

Then, the control unit 301 specifies a system configuration based on the construction conditions of the RPA system 100 included in the collected information ((2) in FIG. 14). For example, the control unit 301 may specify the system configuration of the RPA system 100 based on the registration upper limit number of robots corresponding to the storage capacity, the simultaneous operation upper limit number of robots corresponding to the number of cores and the memory size, and the like.

Subsequently, the control unit 301 estimates the costs for constructing the RPA system 100 from the specified system configuration to determine an estimated amount of money ((3) in FIG. 14), and compares the determined estimated amount of money with the budget amount ((4) in FIG. 14).

In a case where the estimated amount of money is within the budget amount, the control unit 301 outputs the determined estimated amount of money ((5) in FIG. 14). For example, the control unit 301 may output display information for displaying the display screen 901 including the estimated amount of money to cause the display device 211 of the customer terminal 201 or the display device 221 of the vendor terminal 202 to display the display information.

In a case where the estimated amount of money exceeds the budget amount, the control unit 301 outputs a warning ((6) in FIG. 14). For example, the control unit 301 may output display information for displaying the display screen 902 including the warning to cause the display device 211 of the customer terminal 201 or the display device 221 of the vendor terminal 202 to display the display information.

As described above, according to the embodiment, the control unit 301 may specify a system configuration that satisfies the construction conditions of the RPA system 100 input to the input screen 400.

For example, in the above-described embodiment, the storage unit 302 stores the registration upper limit information 700, in which the storage capacity is associated with the registration upper limit number of robots per server. For example, the control unit 301 specifies, from the registration upper limit information 700, the registration upper limit number associated with the storage capacity, input as performance information in the input screen 400, of the server to be deployed. The control unit 301 determines the number of servers to be deployed in the RPA system 100 based on the number of robots, input in the input screen 400, to be operated in the RPA system 100 as the construction target, and the specified registration upper limit number. This makes it possible to estimate the configuration of the RPA system 100 more accurately.

In the above-described embodiment, the storage unit 302 stores the simultaneous operation upper limit information 1000, in which the number of cores and the memory size are associated with the simultaneous operation upper limit number indicating the number of robots simultaneously operable per server. For example, the control unit 301 specifies, from the simultaneous operation upper limit information 1000, the operation upper limit number corresponding to the number of cores and the memory capacity, input as performance information in the input screen 400, of the server to be deployed. Then, the control unit 301 determines the number of servers to be deployed in the RPA system 100 based on the number of simultaneous operations which is input in the input screen 400 and indicates the number of robots to be simultaneously operated in the RPA system 100 as the construction target, and the specified operation upper limit number. This makes it possible to estimate the configuration of the RPA system 100 more accurately.

Then, the control unit 301 calculates an estimated amount of money in accordance with the specified system configuration, and outputs a warning when the estimated amount of money exceeds the budget amount. This may reduce a risk raised by inaccuracy in estimation in the construction of the RPA system 100.

In the above-described embodiment, for example, the control unit 301 outputs a warning when a predetermined item is not input in the input screen 400. With this, in a case where there is omission in the information collected from the customer, it is possible to prompt the customer to provide the information. Thus, it is possible to suppress a decrease in accuracy of cost estimation due to omission in the information collected.

In the above-described embodiment, in a case where a predetermined item is not input in the input screen 400, the control unit 301 calculates the estimated amount of money by adding a risk cost for the evaluation of the risk of a decrease in estimation accuracy due to the fact that the predetermined item is not input. Thus, for example, it is possible to reduce a risk of occurrence of a state of being below cost or the like due to inaccuracy of the estimation caused by input omission when a service is provided to the customer.

In the above-described embodiment, the storage unit 302 stores the status information 1201 indicating the progress of the construction of the RPA system 100. For example, in the case where the status of the business negotiation identified by the service ID to be processed is a predetermined status in which the warning necessity is set to YES in the warning target designation information 1202, the control unit 301 suppresses the output of a warning. This may suppress output of a warning in a case of a business negotiation where the transaction amount of money has been determined, for example.

Although the embodiment has been exemplified above, the embodiment is not limited thereto. For example, the operation flows described above are exemplary, and the embodiment is not limited thereto. Where possible, the order of performing the types of processing in the operation flows may be changed, the operation flows may further include a different type of processing, or some of the types of the processing in the operation flows may be omitted. For example, the processing of S1310 in FIG. 13 may be omitted.

In the above-described embodiment, an example in which the support server 205 presents the input screen 400 as a web page and collects information on the construction of the RPA system 100 is described, but the embodiment is not limited thereto. For example, in another embodiment, exchange of information between the support server 205, and the customer terminal 201 and the vendor terminal 202 may be carried out via mail. In still another embodiment, a construction operator of the service providing vendor may input information obtained from the customer by interview over the telephone or the like, to the support server 205 through the vendor terminal 202.

In the above-described embodiment, an example in which the support server 205 collects information on the RPA system 100 in the input screen 400 as a web service is described, but the embodiment is not limited thereto. For example, the processes of the above-described embodiment may be implemented as macros executable by applications such as spreadsheet software. In this case, a terminal on which the applications run may execute the processing executed by the control unit 301 based on the information on the RPA system 100 having been input to the applications.

In the above-described embodiment, an example in which the number of servers used to construct the RPA system 100 is specified as the system configuration of the RPA system 100 is described, but the embodiment is not limited thereto. For example, in another embodiment, the system configuration of the RPA system 100 may be specified in other units such as the number of cores, memory size, and the like.

In the above-described embodiment, the control unit 301 operates as the reception section 311 in the processing of S1301, for example. For example, the control unit 301 operates as the specifying section 312 in the processing of S1305. The control unit 301 operates as the determination section 313 in the processing of S1306, for example. The control unit 301 operates as the output section 314 in the processing of S1311, for example.

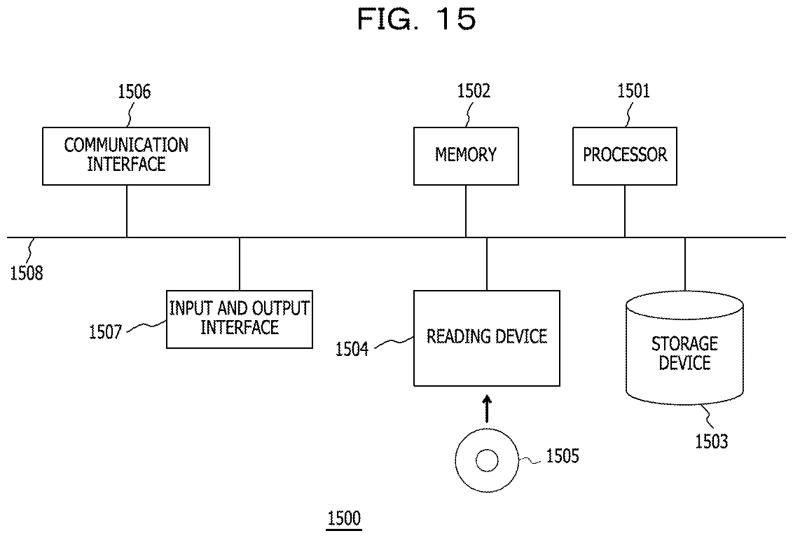

FIG. 15 is a diagram exemplifying a hardware configuration of a computer 1500 to implement the support server 205 according to the embodiment. The hardware configuration in FIG. 15 to implement the support server 205 includes, for example, a processor 1501, a memory 1502, a storage device 1503, a reading device 1504, a communication interface 1506, and an input and output interface 1507. The processor 1501, the memory 1502, the storage device 1503, the reading device 1504, the communication interface 1506, and the input and output interface 1507 are coupled to each other via a bus 1508, for example.

The processor 1501 may be, for example, a single processor, a multiprocessor, or a multicore processor. The processor 1501 uses the memory 1502 to execute a program in which the procedures of the above-described operation flows are described, thereby providing some or all of the functions of the above-described units and sections, for example. For example, the processor 1501 of the support server 205 reads and executes a program stored in the storage device 1503, thereby operating as the reception section 311, the specifying section 312, the determination section 313, and the output section 314.

The memory 1502 is, for example, a semiconductor memory, and may include a RAM region and a ROM region. The storage device 1503 is, for example, a hard-disk drive, a semiconductor memory such as flash memory, or an external storage device. RAM is an abbreviation for random-access memory. ROM is an abbreviation for read-only memory.

The reading device 1504 accesses a removable storage medium 1505 in accordance with an instruction of the processor 1501. The removable storage medium 1505 is realized by, for example, a semiconductor device, a medium to and from which information is input and output by magnetic action, a medium to and from which information is input and output by optical action, or the like. The semiconductor device is, for example, a Universal Serial Bus (USB) memory. The medium to and from which information is input and output by magnetic action is, for example, a magnetic disk. The medium to and from which information is input and output by optical action is, for example, a CD-ROM, DVD, Blu-ray Disc (Blu-ray is a registered trademark), or the like. CD is an abbreviation for compact disc. DVD is an abbreviation for Digital Versatile Disk.

The storage unit 302 includes the memory 1502, the storage device 1503, and the removable storage medium 1505, for example. For example, the storage device 1503 of the support server 205 stores the customer information 500, the construction condition information 600, the registration upper limit information 700, the estimation information 800, the simultaneous operation upper limit information 1000, the status information 1201, and the warning target designation information 1202.

The communication interface 1506 communicates with other devices in accordance with, for example, an instruction from the processor 1501. For example, the support server 205 may be coupled to the customer terminal 201 and the vendor terminal 202 via the communication interface 1506 by wired or wireless communication to transmit and receive data. The communication interface 1506 is an example of the communication unit 303.

The input and output interface 1507 may be, for example, an interface between an input device and an output device. The input device is, for example, a device such as a keyboard, a mouse, or a touch panel that receives an instruction from a user. The output device is, for example, a display device such as a display and an audio device such as a speaker.

Each of the programs according to the embodiment is provided to the support server 205, for example, in the following form.

(1) Installed in advance, in the storage device 1503.

(2) Provided by the removable storage medium 1505.

(3) Provided from a server such as a program server.

The hardware configuration of the computer 1500 for the implementation of the support server 205 described with reference to FIG. 15 is exemplary, and the embodiment is not limited thereto. For example, part of the above-described configuration may be deleted, or a new configuration may be added thereto. In another embodiment, for example, some or all of the functions of the control unit 301 described above may be mounted as hardware such as an FPGA, SoC, ASIC, and PLD. FPGA is an abbreviation for field-programmable gate array. SoC is an abbreviation for a system-on-a-chip. ASIC is an abbreviation for application-specific integrated circuit. PLD is an abbreviation for programmable logic device.

Some embodiments have been described above. However, the embodiments are not limited to the above-described embodiments. It is to be appreciated that the embodiments include a number of types of variations and alternatives of the above-described embodiments. For example, it would be appreciated that various types of embodiments are able to be embodied by modifying the elements without departing from the scope of the gist of the embodiments. It would also be appreciated that various types of embodiments are able to be implemented by appropriately combining a plurality of the elements disclosed according to the above-described embodiment. Moreover, those skilled in the art would appreciate that various types of embodiments are able to be implemented by deleting some elements from all the elements described in the embodiment or adding some elements to the elements described in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an information processing program for causing a computer to execute processing, the processing comprising:
receiving input of construction conditions and performance information, the construction conditions including a number of robots to be operated in a construction target system, the performance information including a value that corresponds to performance of a deployment server to be deployed in the construction target system;
transforming the received construction conditions into a system configuration that satisfies the received construction conditions;
obtaining an estimated index corresponding to amount of loads for constructing the construction target system in accordance with the system configuration; and
outputting a warning in response to detecting that the estimated index exceeds a predetermined amount stored in a storage device.

2. The non-transitory computer-readable storage medium according to claim 1,
wherein the storage device is configured to store registration upper limit information, the registration upper limit information indicating a storage capacity and a registration upper limit number corresponding to the storage capacity, the registration upper limit number being a registration upper limit number of robots able to be registered per server, and
the transforming of the received construction conditions includes,
specifying, from the registration upper limit information, a registration upper limit number corresponding to a storage capacity of the deployment server input as the performance information, and
determining a number of the deployment servers to be deployed in the construction target system based on the number of robots and the registration upper limit number corresponding to the storage capacity of the deployment server.

3. The non-transitory computer-readable storage medium according to claim 1,
wherein the storage device is configured to store simultaneous operation upper limit information, the simultaneous operation upper limit information indicating a number of cores, a memory size, and a simultaneous operation upper limit number indicating the number of robots simultaneously operable per server,
the construction conditions include a number of simultaneous operations indicating the number of robots to be simultaneously operated in the construction target system, and
the transforming of the received construction conditions includes, specifying, from the simultaneous operation upper limit information, an operation upper limit number corresponding to the number of cores and the memory size of the deployment server input as the performance information, and
determining the number of the deployment servers to be deployed in the construction target system based on the number of simultaneous operations, and the operation upper limit number corresponding to the number of cores and the memory size of the deployment server.

4. The non-transitory computer-readable storage medium according to claim 1, the processing executed by the computer further comprising:
outputting a warning in a case that a predetermined item is not input in the construction conditions received in the receiving.

5. The information processing program according to claim 1,
wherein, in a case that a predetermined item is not input in the construction conditions received in the receiving, the obtaining of the estimated index determines the estimated index by adding an additional load to the estimated amount of loads, the additional load being a load obtained by evaluating a risk of a decrease in estimation accuracy due to a fact that the predetermined item is not input.

6. The information processing program according to claim 1,
wherein the storage device stores a status indicating a progress of the construction of the construction target system, and
the outputting suppresses the output of the warning in a case that the status is a predetermined status.

7. An information processing apparatus comprising:
a memory; and
a processor coupled to the memory, the processor being configured to perform processing, the processing including:
receiving input of construction conditions and performance information, the construction conditions including a number of robots to be operated in a construction target system, the performance information including a value that corresponds to performance of a deployment server to be deployed in the construction target system;
transforming the received construction conditions into a system configuration that satisfies the received construction conditions;
obtaining an estimated index corresponding to an amount of loads for constructing the construction target system in accordance with the system configuration; and
outputting a warning in response to detecting that the estimated index exceeds a predetermined amount stored in a storage device.
